(19) United States
(12) Patent Application Publication
(10) Pub. No.: US 2024/0248884 A1
(43) Pub. Date: Jul. 25, 2024

(54) AUTOMATED SCHEMA LIFECYCLE MANAGEMENT

(71) Applicant: American Express Travel Related Services Company, Inc., New York, NY (US)

(72) Inventors: Timothy Kitipong Hundt, Phoenix, AZ (US); Gabriel Jones, New York, NY (US)

(21) Appl. No.: 18/100,955

(22) Filed: Jan. 24, 2023

(51) Int. Cl. G06F 16/21

(52) U.S. Cl. CPC G06F 16/211

(57) ABSTRACT

Disclosed are various embodiments for automated schema lifecycle management. A first revision of the schema is identified from one or more revision(s). Then, the revision is evaluated to determine a state identifier or a classification. Next, a second revision of the schema is identified, wherein the second revision of the schema contains at least one of a second state or a second classification of the second revision of the schema. Then, a determination of compatibility between the first revision of the schema and the second revision of the schema is made based at least in part on one or more compatibility rules. Finally, an automated action is performed based at least in part on the second revision of the schema being compatible with the first revision of the schema.

### BACKGROUND

Schemas define the structure for data or processes and define the relationships of the data. In some situations, software applications or business processes use schemas to structure their data. Schemas can be modified to address evolving needs. For example, optional and required data attributes could be modified or updated, among other changes.

### BRIEF DESCRIPTION OF THE DRAWINGS

Many aspects of the present disclosure can be better understood with reference to the following drawings. The components in the drawings are not necessarily to scale, with emphasis instead being placed upon clearly illustrating the principles of the disclosure. Moreover, in the drawings, like reference numerals designate corresponding parts throughout the several views.

FIG. 1 is a drawing of a network environment according to various embodiments of the present disclosure.

FIG. 2 is a drawing depicting one of several embodiments of the present disclosure, including an example of the schema.

FIG. 3A is a flowchart illustrating one example of functionality implemented as portions of an application executed in a computing environment in the network environment of FIG. 1 according to various embodiments of the present disclosure.

FIG. 3B is a flowchart illustrating one example of functionality implemented as portions of an application executed in a computing environment in the network environment of FIG. 1 according to various embodiments of the present disclosure.

FIG. 4A is a flowchart illustrating one example of functionality implemented as portions of an application executed in a computing environment in the network environment of FIG. 1 according to various embodiments of the present disclosure.

FIG. 4B is a flowchart illustrating one example of functionality implemented as portions of an application executed in a computing environment in the network environment of FIG. 1 according to various embodiments of the present disclosure.

FIG. 5A is a flowchart illustrating one example of functionality implemented as portions of an application executed in a computing environment in the network environment of FIG. 1 according to various embodiments of the present disclosure.

FIG. 5B is a flowchart illustrating one example of functionality implemented as portions of an application executed in a computing environment in the network environment of FIG. 1 according to various embodiments of the present disclosure.

### DETAILED DESCRIPTION

Disclosed are various approaches for automating management of the lifecycle of a schema. Generally, a lifecycle for a schema is managed manually, and systems cannot automatically determine when the schema has changed or whether the changes are optional. If the new revision of a schema is applied to a system without determining compatibility, the system or process can produce errors. Further, the previous revision(s) can continue to be used by systems in error instead of being deprecated, retired, or deleted.

In contrast to other approaches, which involve evaluating a schema manually, the approaches herein automate the evaluation of the schema and management of the schema lifecycle. In some examples, an automatic versioning alignment service can be used to determine a classification of a revision of the schema. In other examples, an automatic state management service can be used to determine a state of the revision of the schema. In some examples, an automatic revision storage service can be used to determine the storage location of the revision of the schema. In other examples, an automatic execution service can be used to install the revision of the schema or apply the changes to the revision of the schema.

For example, when a revision of the schema is detected, the automatic versioning alignment service can determine and apply the classification to the new revision of the schema. The automatic state management service can detect or assign a state to the revision of the schema. The automatic revision storage can determine and store the revision of the schema based at least in part on the classification, the state, or a geographical region. Accordingly, the various embodiments of the present disclosure can save valuable time and resources compared to approaches that require manual user input. Various embodiments of the present disclosure can also improve the quality and consistency of data stored across multiple systems due to the synchronization of data between systems.

In the following discussion, a general description of the system and its components is provided, followed by a discussion of the operation of the same. Although the following discussion provides illustrative examples of the operation of various components of the present disclosure, the use of the following illustrative examples does not exclude other implementations that are consistent with the principals disclosed by the following illustrative examples.

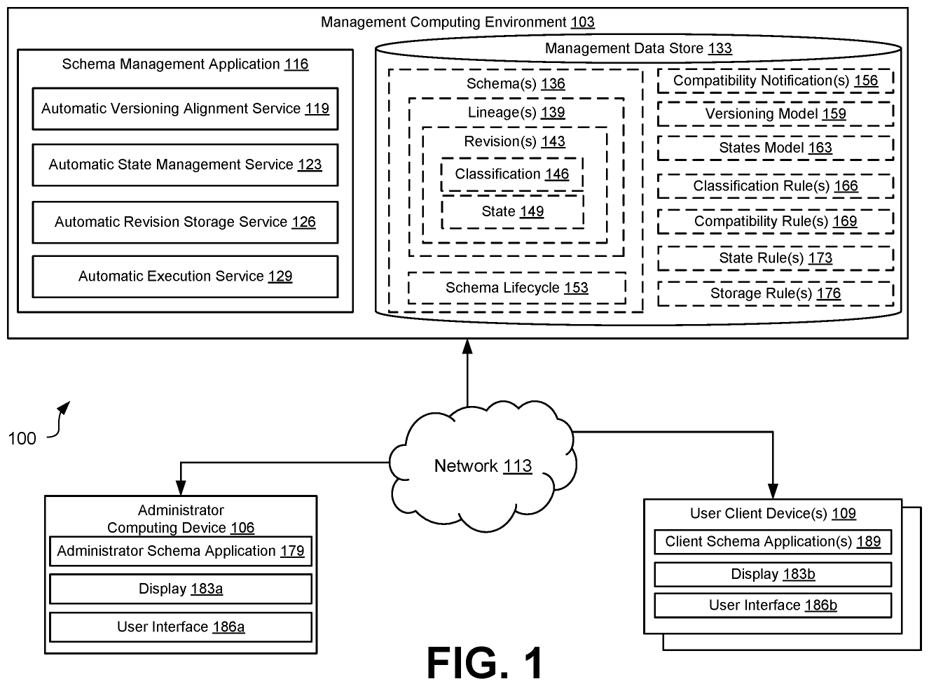

With reference to FIG. 1, shown is a network environment 100 according to various embodiments. The network environment 100 can include a management computing environment 103, an administrator computing device 106, and one or more user client device(s) 109, which can be in data communication with each other via a network 113.

The network 113 can include wide area networks (WANs), local area networks (LANs), personal area networks (PANs), or a combination thereof. These networks can include wired or wireless components or a combination thereof. Wired networks can include Ethernet networks, cable networks, fiber optic networks, and telephone networks such as dial-up, digital subscriber line (DSL), and integrated services digital network (ISDN) networks. Wireless networks can include cellular networks, satellite networks, Institute of Electrical and Electronic Engineers (IEEE) 802.11 wireless networks (e.g., WI-FI®), BLUETOOTH® networks, microwave transmission networks, as well as other networks relying on radio broadcasts. The network 113 can also include a combination of two or more networks 113. Examples of networks 113 can include the Internet, intranets, extranets, virtual private networks (VPNs), and similar networks.

The management computing environment 103 can include one or more computing devices that include a processor, a memory, and/or a network interface. For example, the computing devices can be configured to perform computations on behalf of other computing devices or applications. As another example, such computing devices can host and/or provide content to other computing devices in response to requests for content.

Moreover, the management computing environment 103 can employ a plurality of computing devices that can be arranged in one or more server banks or computer banks or other arrangements. Such computing devices can be located in a single installation or can be distributed among many different geographical locations. For example, the management computing environment 103 can include a plurality of computing devices that together can include a hosted computing resource, a grid computing resource or any other distributed computing arrangement. In some cases, the management computing environment 103 can correspond to an elastic computing resource where the allotted capacity of processing, network, storage, or other computing-related resources can vary over time.

Various applications or other functionality can be executed in the management computing environment 103. The components executed by the management computing environment 103 include a schema management application 116, and other applications, services, processes, systems, engines, or functionality not discussed in detail herein Moreover, the schema management application 116 contains component applications such as an automatic versioning alignment service 119, an automatic state management service 123, an automatic revision storage service 126, and an automatic execution service 129 which would be executed by the management computing environment 103.

Also, various data is stored in a management data store 133 that is accessible to the management computing environment 103. The management data store 133 can be representative of a plurality of management data stores 133, which can include relational databases or non-relational databases such as object-oriented databases, hierarchical databases, hash tables or similar key-value data stores, as well as other data storage applications or data structures. Moreover, combinations of these databases, data storage applications, and/or data structures can be used together to provide a single, logical, data store. The data stored in the management data store 133 is associated with the operation of the various applications or functional entities described below. This data can include one or more schema(s) 136, one or more compatibility notification(s) 156, a versioning model 159, a states model 163, one or more classification rule(s) 166, one or more compatibility rule(s) 169, one or more state rule(s) 173, one or more storage rule(s) 176, and potentially other data.

Accordingly, the schema(s) 136 can store various data. The data stored in the schema(s) 136 is associated with the operation of the various applications or functional entities described below. This data can include one or more lineage(s) 139, a schema lifecycle 153, one or more temporary lineage(s) 139, one or more temporary schema storage(s) 203, and potentially other data. Further, the one or more lineage(s) 139 can store revision(s) 143, temporary revision(s) 143, and potentially other data. Moreover, the revision(s) 139 can store a classification 146, a state 149, and potentially other data.

The schema(s) 136 can represent a structure for data or processes and define the relationships of the data. The schema(s) 136 can be used to organize data, identify specific types or instances of data, and can define, identify, or represent data in a database. In some examples, the schema(s) 136 can provide information about tables, views, rows, columns, and procedures. In other examples, the schema(s) 136 can define the structure of data provided or received from an application programming interface (API). In some examples, the schema(s) 136 can be read-only. In some examples, a plurality of schema(s) 136 can be used to define, identify, or represent the same set of data in a database. The schema(s) 136 can contain one or more of the lineage(s) 139, the revision(s) 143, the classification 146, the state 149, the schema lifecycle 153, and potentially other data. The schema(s) 136 can contain various types of data types, data attributes (a name, address, zip code, date of birth, city, state, vendor ID, retailer ID, product ID, ship date, etc.), and/or specify data format(s). The data attributes can be required or optional.

The schema(s) 136 can contain the lineage(s) 139. The lineage(s) 139 can represent a location to store the revision(s) 143 of the schema(s) 136. The lineage(s) 139 can be created based at least in part on the classification rule(s) 166 and the classification 146 of the revision(s) 143 of the schema(s) 136. The lineage(s) 139 can be labeled and used based at least in part on the versioning model 159. In other examples, the lineage(s) 139 can be created based at least in part on the state rule(s) 173 and the state 149 of the revision(s) 143 of the schema(s) 136.

In some examples, the versioning model 159 can be a semantic versioning model. The semantic versioning model uses the classification 146 of major, minor, and patch. The semantic versioning model uses the format “Major. Minor. Patch.” For example, the lineage of “1.X.X” would represent this is the first major revision of the schema 136. In other examples, “1.2.1” would represent that the revision 143 is in the first lineage, has two minor revisions, and one patch revision.

For example, the classification 146 of “major” represents that the revision(s) 143 is incompatible with a prior revision. In some examples, when the revision(s) 143 are determined to be the classification 146 of “major,” a temporary lineage 139 can be generated by the schema management application 116. In other examples, the temporary lineage 139 can be generated based at least in part on the classification rule(s) 166. The revision(s) 143 can be stored in the temporary lineage 139 if the classification 146 of the revision(s) 143 is “major.” In some examples, adding the required attribute(s) to the revision(s) 143 of the schema(s) 136 can cause the schema management application 116 to determine the classification 146 of the revision(s) 143 of the schema(s) 136 is “major.” In other examples, removing the required attribute(s) from the revision(s) 143 of the schema(s) 136 can cause the schema management application 116 to determine the classification 146 of the revision(s) 143 of the schema(s) 136 is “major.”

For example, the classification 146 of “minor” represents that the revision(s) 143 is compatible with the prior revision but can alter functionality. In some examples, when the revision(s) 143 of the schema(s) 136 are determined to be the classification 146 of “minor,” the revision(s) 143 of the schema(s) 136 can be changed to include the additional functionality. In other examples, adding or removing the optional attribute(s) from the revision(s) 143 of the schema(s) 136, can cause the schema management application 116 to determine the revision(s) 143 of the schema(s) 136 is “minor.”

For example, the classification 146 of “patch” represents that the revision(s) 143 of the schema(s) 136 is compatible with the prior revision and does not alter functionality. In some examples, changing a description of the optional or required attribute of the revision(s) 143 of the schema(s) 136 can cause the schema management application 116 to determine the revision(s) 143 of the schema(s) 136 is “patch.” In other examples, fixing a bug in the revision(s) 143 of the schema(s) 136 can cause the schema management application 116 to determine the revision(s) 143 of the schema(s) 136 is “patch.”

The revision(s) 143 of the schema(s) 136 can represent the schema 136 in use. In some examples, if the schema(s) 136 does not contain the prior revision, the revision 143 of the schema(s) 136 can be a new revision to be evaluated by the schema management application 116. In other examples, the revision(s) 143 of the schema(s) 136 can be stored in the management data store 133. In some examples, the revision(s) 143 of the schema(s) 136 can be the classification of the “major,” “minor,” or “patch.”

In other examples, the classification 146 of the revision(s) 143 of the schema(s) 136 can represent compatibility and changes in the revision(s) 143 of the schema(s) 136. The changes can be changes such as optional or required data attribute(s). In some examples, the classification 146 can be based at least in part on the one or more classification rule(s) 166. In other examples, the classification 146 can be based at least in part on the versioning model 159. In other examples, the classification 146 can be further based at least in part on a combination of the versioning model 159 and the classification rule(s) 166. In some examples, the classification 146 of one or more of the revision(s) 143 of the schema(s) 136 can be the same.

Next, the state 149 can represent the current state of the revision(s) 143 of the schema(s) 136. In some examples, the state 149 can represent the current state of the schema lifecycle 153. The state 149 of the revision(s) 143 of the schema(s) 136 can be based at least in part on the one or more state rule(s) 173. In other examples, the state 149 can be based at least in part on the states model 163. In other examples, the state 149 can be further based at least in part on a combination of the states model 163 and the state rule(s) 173. In other examples, the state 149 can be stored in the schema(s) 136. In other examples, the state 149 can be used to identify the state of the revision(s) 143 of the schema(s) 136. In some example, the state 149 of one or more of the revision(s) 143 of the schema(s) 136 can be the same.

In some examples, the states model 163 can be a five-stage model. The five-stage model contains five states. These states 149 can include a “draft state,” “discarded state,” “live state,” “deprecated state,” and “retired state.” In some examples, the states model 163 can be based at least in part on a user input received via the administrator schema application 179. The revision(s) 143 of the schema(s) 136 can transition through the one or more states 149 of the states model 163. In other examples, the states model 163 can be provided by the user via the administrator schema application 179.

For example, the “draft state” is a draft schema that embodies a working copy of the revision(s) 143 of the schema(s) 136. The revision(s) 143 with the “draft state” cannot have been used previously. In some examples, the “draft state” is the initial state of the revision(s) 143 of the schema(s) 136. In other examples, the “draft state” can be the revision(s) 143 of the schema(s) 136 that is being prepared to be transitioned to another state. The schema management application 116 can perform an action to the “draft state” based at least in part on the state rule(s) 173. The state rule(s) 173 can provide for the revision(s) 143 of the schema(s) 136 in the “draft state” to be discarded after a specified period (one day, one week, one month, etc.). In other examples, the state rule(s) 173 can provide for the revision(s) 143 of the schema(s) 136 in the “draft state” to be moved to the “live state” based at least in part on an action taken by the user via the administrator schema application 179 or a condition (the “draft state” being the first revision, arrival of scheduled date for “draft state” to transition to “live state,” etc.) being met.

For example, the “discarded state” is the draft schema that embodies a working copy of the revision(s) 143 of the schema(s) 136 that can not be used or has been abandoned. For example, the revision(s) 143 of the schema(s) 136 with the “draft state” can be transitioned to the “discarded state” after a duration of time since created, duration since last modified, duration since last accessed, change in the state 149 of the revision(s) 143 of the schema(s) 136 used as the basis for the “draft state” revision, change in the state for the revision(s) 143 of the schema(s) 136 changing the lineage(s) 139, etc. A conversion from the “draft state” to the “discarded state” is based at least in part on the state rule(s) 173. In other examples, the state rule(s) can provide for the revision(s) 143 of the schema(s) 136 in the “draft state” to be transitioned to the “discarded state” based at least in part on an action taken by the user via the administrator schema application 179.

For example, the “live state” is the revision(s) 143 of the schema(s) 136 that embodies a working copy and is fully available for use. In some examples, the automatic state management service 123 can determine when the “draft state” is transitioned to the “live state”. For example, the revision(s) 143 of the schema(s) 136 can be transitioned to the “live state” if it does not detect any prior revisions. In other examples, the revision(s) 143 of the schema(s) 136 with the “draft state” can be transitioned to the “live state” after a specified period provided by the state rule(s) 173. In some examples, the revision(s) 143 of the schema(s) 136 can be transitioned to the “live state” based at least in part on a command by the user via the administrator schema application 179. In other examples, the automatic state management service 123 can monitor the schema(s) 136 for an external condition (ceasing use of prior revision, etc.) to determine when to set the revision(s) 143 of the schema(s) 136 to the “live state.”

For example, the “deprecated state” is the state after the revision(s) 143 of the schema(s) 136 when the “live state” is replaced by the revision(s) 143 in the “draft state”. In some examples, the automatic state management service 123 can move the revision(s) 143 of the schema(s) 136 with the “live state” to the “deprecated state” upon determination of a criteria. For example, the revision(s) 143 of the schema(s) 136 can be transitioned to the “deprecated state” when the data standards or data format has changed, the lineage(s) 139 of the schema(s) 136 have changed, or the revision(s) 143 of the schema(s) 136 has had the “live state” for a certain period of time. In other examples, the revision(s) 143 of the schema(s) 136 can be transitioned to the “deprecated state” based at least in part on a command by the user via the administrator schema application 179.

For example, the “retired state” is the revision(s) 143 of the schema(s) 136 that were in the “live state” or the “deprecated state” but are no longer available for use. In some examples, when the classification 146 of the revision(s) 143 of the schema(s) 136 change, the state of the revision(s) 143 of the schema(s) 136 can be changed to the “retired state”. In some examples, the “live state” can be transitioned to the “retired state” without transitioning to the “deprecated state”. In other examples, the revision(s) 143 of the schema(s) 136 can be transitioned to the “retired state” based at least in part on a command by the user via the administrator schema application 179.

The compatibility notification(s) 156 can represent information regarding compatibility between the different revision(s) 143 of the schema(s) 136. In some examples, the compatibility notification(s) 156 can be used by the automatic versioning alignment service 119 to determine the classification 146 of the revision(s) 143 of the schema(s) 136. In some examples, the compatibility notification(s) 156 can be used by the automatic state management service 123 to determine the state 149 of the revision(s) 143 of the schema(s) 136. In other examples, the automatic revision storage service 126 to determine where to store the revision 143 of the schema 136. The automatic revision storage service 126 can also use the information contained in the compatibility notification(s) 156 to determine if the temporary schema storage or the temporary lineage 139 need to be generated.

The classification rule(s) 166 include rules, models, and/or configuration data for the various algorithms or approaches employed by the schema management application 116 to determine the classification 146 of the revision(s) 143 of the schema(s) 136. In some examples, the schema management application 116 can determine the classification 146 of the revision 143 of the schema 136 based at least in part on the classification rule(s) 166. For example, the classification rule(s) can be used by the schema management application 116 to determine the classification 146 is “major,” “minor,” or “patch” based at least in part on the semantic versioning model. The classification rule(s) 166 can be modified by the user via the administrator schema application 179.

The compatibility rule(s) 169 include rules, models, and/or configuration data for the various algorithms or approaches employed by the schema management application 116 to determine compatibility between the different revision 143 (e.g., the first revision 143, the second revision 143, an active revision 143, a subsequent revision 143). In some examples, the schema management application 116 can determine compatibility between the revision(s) 143 by comparing the schema(s) 136 of the revision 143. For example, adding required attributes to the subsequent revision 143 that were not in the first revision 143 could make the revisions incompatible. In some examples, the compatibility rule(s) 169 can be used by the automatic versioning alignment service to determine the classification 146 of the revision(s) 143 of the schema(s) 136. In other examples, the automatic revision storage service 126 can use the compatibility rule(s) 169 to determine where to store the revision(s) 143 of the schema(s) 136. The compatibility rule(s) 169 can be modified by the user via the administrator schema application 179.

The state rule(s) 173 include rules, models, and/or configuration data for the various algorithms or approaches employed by the schema management application 116 to determine the state 149 of the revision(s) 143 of the schema(s) 136. In some examples, the state rule(s) 173 can contain rules pertaining to the states 149 of the states model 163. For example, the state rule(s) 173 can include the rule that determines when the revision 143 in the “draft state” should be transitioned to the “live state”. In other examples, the automatic state management service 123 can use the state rule(s) 173 to determine the state 149 of the revision(s) 143 of the schema(s) 136. The state rule(s) 173 may be modified by the user via the administrator schema application 179.

The storage rule(s) 176 include rules, models, and/or configuration data for the various algorithms or approaches employed by the schema management application 116 to determine how the revision(s) 143 of the schema(s) 136 can be stored. In some examples, the storage rule(s) 176 can be used by the schema management application 116 to determine when the temporary storage or the temporary lineage 139 are generated. For example, if the classification 146 of the revision 143 of the schema 136 is major, the schema management application 116 can generate the temporary lineage 139 to store the revision 143. The storage rule(s) 176 can be modified by the user via the administrator schema application 179.

The automatic versioning alignment service 119 can be executed to assign the classification 146 to the revision(s) 143 of the schema(s) 136. In some examples, the automatic versioning alignment service 119 can use the semantic versioning model. In other examples, the automatic versioning alignment service 119 can use the versioning model 159 provided by the user via the administrator schema application 179. In other examples, the automatic versioning alignment service 119 can receive commands from the user via the administrator schema application 179. For example, if the schema(s) 136 are using the semantic versioning model and the current version of the lineage 139 is 1.0.0, when a second revision 143 of the schema 136 is determined to be compatible, the automatic versioning alignment service 119 can automatically change the second revision from “1.x.x” to “1.1.0” to show the classification 146 of the second revision 143 was minor.

The automatic state management service 123 can be executed to assign the state 149 to the revision(s) 143 of the schema(s) 136. In some examples, the automatic state management service 123 can use the five-stage model. In other examples, the automatic state management service 123 can use the states model 163 provided by the user via the administrator schema application 179. In some examples, the automatic state management service 123 can receive commands from the user via the administrator schema application 179. For example, if the schema(s) 136 are using the five-stage model and a first revision 143 is determined to be in the “draft state,” the automatic state management service can transition the state 149 of the first revision 143 to the “live state.”

The automatic revision storage service 126 can be executed to store the revision(s) 143 of the schema(s) based at least in part on the classification 146, the state 149, or a geographical location. In some examples, the automatic revision storage service 126 can store the revision(s) 143 of the schema(s) 136 in the temporary schema storage 203. In other examples, the automatic revision storage service 126 can generate a temporary lineage based at least in part on one or more classification rule(s) 166, one or more compatibility rule(s) 169, one or more state rule(s) 173, or one or more storage rule(s) 176. In other examples, the automatic revision storage service 126 can store the revision(s) 143 of the schema(s) 136 within a single database table with indexes. In other examples, the automatic revision storage service 126 can store the revision(s) 143 of the schema(s) 136 geographically to manage the schema(s) 136 closer to their usage. In some other examples, the revision(s) 143 of the schema(s) 136 can be stored in a folder. The automatic revision storage service 126 can store each of the schema(s) independently of the other. Each of the schema(s) can have their own versioning model 159 or states model 163.

The automatic execution service 129 can be executed to automatically apply the changes to the schema(s) 136 based upon the state 149 of the revision(s) 143 of the schema(s) 136. In other examples, the automatic execution service 129 can be executed to automatically apply the changes based upon the classification 146 of the revision(s) 143 of the schema(s) 136. The automatic execution service 129 can control access to the schema(s) 136. In other examples, the user can send commands to the automatic execution service 129 via the administrator schema application 179.

The administrator computing device 106 is representative of a plurality of computing devices that can be coupled to the network 113. The administrator computing device 106 can include a processor-based system such as a computer system. Such a computer system can be embodied in the form of a personal computer (e.g., a desktop computer, a laptop computer, or similar device), a mobile computing device (e.g., personal digital assistants, cellular telephones, smartphones, web pads, tablet computer systems, music players, portable game consoles, electronic book readers, and similar devices), media playback devices (e.g., media streaming devices, BluRay® players, digital video disc (DVD) players, set-top boxes, and similar devices), a videogame console, or other devices with like capability. The administrator computing device 106 can include one or more displays 183a such as liquid crystal displays (LCDs), gas plasma-based flat panel displays, organic light emitting diode (OLED) displays, electrophoretic ink (“E-ink”) displays, projectors, or other types of display devices. In some instances, the display 183a can be a component of the administrator computing device 109 or can be connected to the user client device 109 through a wired or wireless connection.

The administrator computing device 106 can be configured to execute various applications such as an administrator schema application 179 or other applications. The administrator schema application 179 can be executed in the administrator computing device 106 to access network content served up by the management computing environment 103 or other servers, thereby rendering a user interface 186a on the display 183a. To this end, the administrator schema application 179 can include a browser, a dedicated application, or other executable, and the user interface 186a can include a network page, an application screen, or other user mechanism for obtaining user input. The administrator computing device 106 can be configured to execute applications beyond the administrator schema application 179 such as email applications, social networking applications, word processors, spreadsheets, or other applications. However, administrator computing device(s) 106 can be configured to operate in a “headless” configuration without a display 183a. In these configurations, the user interface 186a could be presented to another device over the network 113 (e.g., via the remote desktop protocol (RDP), secure shell (SSH) protocol, etc.).

The administrator schema application 179 can be executed to allow the user to change the data stored in the management data store 133. In some examples, the administrator schema application 179 can be executed to allow the user to change the versioning model 159 or the states model 163. In other examples, the administrator schema application 179 can be executed to allow the user to change the classification rule(s) 166, the compatibility rule(s) 169, the state rule(s) 173, or the storage rule(s) 176. In other examples, the administrator schema application 179 can direct one or more of the automatic versioning alignment service 119, automatic state management service 123, automatic revision storage service 126, or the automatic execution service 129 to execute. In other instances, the administrator schema application 179 could be configured to execute or perform its functions without user intervention. For example, the administrator schema application 179 could be configured to use machine-learning, artificial intelligence, or similar approaches to perform its functions.

The user client device(s) 109 is representative of a plurality of client devices that can be coupled to the network 113. The user client device(s) 109 can include a processor-based system such as a computer system. Such a computer system can be embodied in the form of a personal computer (e.g., a desktop computer, a laptop computer, or similar device), a mobile computing device (e.g., personal digital assistants, cellular telephones, smartphones, web pads, tablet computer systems, music players, portable game consoles, electronic book readers, and similar devices), media playback devices (e.g., media streaming devices, BluRay® players, digital video disc (DVD) players, set-top boxes, and similar devices), a videogame console, or other devices with like capability. The user client device(s) 109 can include one or more displays 183b such as liquid crystal displays (LCDs), gas plasma-based flat panel displays, organic light emitting diode (OLED) displays, electrophoretic ink (“E-ink”) displays, projectors, or other types of display devices. In some instances, the display 183b can be a component of the user client device 109 or can be connected to the user client device(s) 109 through a wired or wireless connection. However, user client devices(s) 109 can be configured to operate in a “headless” configuration without a display 183b. In these configurations, the user interface 186b could be presented to another device over the network 113 (e.g., via the remote desktop protocol (RDP), secure shell (SSH) protocol, etc.).

The user client device(s) 109 can be configured to execute various applications such as a client schema application(s) 189 or other applications. The client schema application(s) 189 can be executed in the user client device(s) 109 to access network content served up by the management computing environment 103 or other servers. In some instances, a client schema application 189 could render a user interface 186b on the display 183b. To this end, the client schema application(s) 189 can include a browser, a dedicated application, or other executable, and the user interface 186b can include a network page, an application screen, or other user mechanism for obtaining user input. The user client device(s) 109 can be configured to execute applications beyond the client schema application(s) 189 such as email applications, social networking applications, word processors, spreadsheets, or other applications.

The client schema application(s) 189 can use schema(s) 136 that are active or in the “live state”. In some examples, the client schema application(s) 189 can use a plurality of the schema(s) 136. The client schema application(s) 189 may not be able to execute the schema(s) 136 unless it is in the “live state” 149 or set as the active schema 136. The user can interact with the user interface 186b on the display 183b of the user client device 109 to change settings of the client schema application(s). For example, the client schema application(s) can run two or more of the schema(s) 136 and the user can disconnect from one of the schema(s) 136.

Next, a general description of the operation of the various components of the network environment 100 is provided. Although the following description provides a general description of the interactions between the various components of the network environment 100, other interactions are also encompassed by the various embodiments of the present disclosure.

To begin, the schema lifecycle 153 facilitates the development of the schema(s) 136. The data contained in the schema(s) 136 could be used by the client schema application(s) 189 to define the relationships between data and instances, or for operations of various applications. The network 113 allows the user client device(s) 109 to use the schema(s) 136 in the management computing environment 103 for operation of the client schema application(s) 189 by using the data stored in the schema(s) 136. However, data is apt to change overtime.

The administrator computing device 106 can change the schema(s) 136 by modifying or saving a new revision 143 of the schema. The new revision 143 could be changed or saved by the user via the administrator schema application 179. The revision(s) 143 of the schema 136 can contain one or more changes. In order to effectively manage the new revision 143, the schema management application 116 contains four components to automatically manage the full lifecycle of the schema 136. First, the schema management application 116 determines the first revision 143. Then, the schema management application 116 determines and stores the versioning model 159. The versioning model 159 can be a preexisting model such as the semantic versioning model or it can be a versioning model 159 provided by the user via the administrator schema application 179. The automatic versioning alignment service 119 of the schema management application 116 determines the classification 146 of the first revision 143 based at least in part on the versioning model 159 and the classification rule(s) 166. The first revision 143 could be the current revision 143 or the new revision 143. The first revision could be the revision 143 of the schema 136 being used by the client schema application(s) 189. If the first revision 143 is the new revision 143, the schema could include changes such as required attributes. Next, the subsequent revision 143 is identified by the schema management application 116. The automatic versioning alignment service 119 can determine if the first revision 143 and the subsequent revision 143 are compatible. If the revisions are compatible, the automatic versioning alignment service 119 will modify the classification of the second revision to indicate compatibility. After the classification 146 of the subsequent revision is modified, the schema management application 116 can perform the automated action such as generating the compatibility notification(s) 156.

Next, the schema management 116 determines and stores the states model 163. The states model 163 can be a preexisting model such as the five-stage model or it can be the states model 163 provided by the user via the administrator schema application 179. The automatic state management service 123 of the schema management application 116 determines the state 149 of the first revision 143 based at least in part on the states model 163 and the state rule(s) 173. The state 149 of the first revision.

Next, the schema management application 116 could query the schema 136 for the subsequent revision 143. If the subsequent revision 143 exists, the automatic state management service 123 of the schema management application 116 determines the classification 146 and the state 149 of the subsequent revision. Then, the subsequent revision 143 is evaluated for changes in the schema 136 and the changes are determined. In response, the schema management application 116 could perform the automated action such as modifying the state 149 of the first revision 143 or initiating installation of the subsequent revision 143.

The schema management application 116 can determine and store the revision storage model. The revision storage model could be a preexisting model or could be provided by the user via the administrator schema application 179. The automatic revision storage service 126 of the schema management application 116 will identify and store the revision 143 temporarily in the management data store 133. The schema management application can determine the classification or state of the revision 143. The automatic revision storage service 126 can store the revision 143 in the schema 136 based at least in part on one or more of the classification 146, the state 149, the storage rule(s) 176, classification rule(s) 166, and compatibility rule(s) 169. In response to storing the revision 143, the schema management application can perform an automated action such as executing the automatic execution service or generating the compatibility notification(s) 156. The compatibility information will be stored in the compatibility notification(s) 156, which can be stored. The compatibility notification(s) 156 can be sent to the administrator computing device 106 or the user client device(s) 109. The compatibility notification(s) 156 can be displayed on the display 183a or the display 183b. In other instances, the client schema application(s) 189 can request installation of the new schema(s) 136. The user client device(s) 109 can use the schema(s) 136 to define the structure for the data dependent on software code or business process.

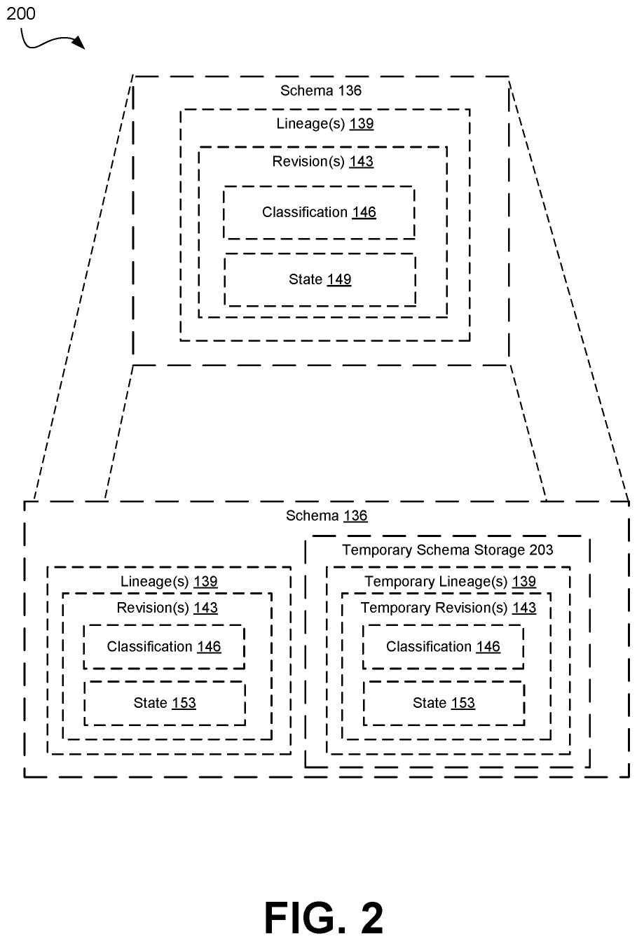

Referring next to FIG. 2, shown is an example of a schema 136 and an example of the schema 136 with temporary schema storage, temporary lineage(s) 139, and temporary revision(s) 143. This arrangement of the schema 136 is merely an example of the many different types of arrangements for the various components contained in the schema 136. The temporary schema storage 203 can be created by the automatic revision storage service 126 or the schema management application 116. The temporary schema lineage 139 can be created based at least in part on the storage rule(s) 176.

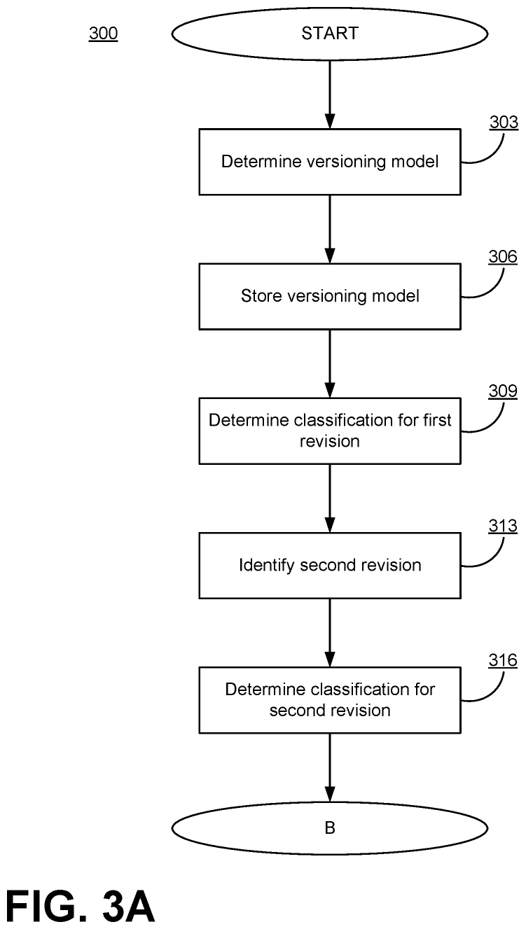

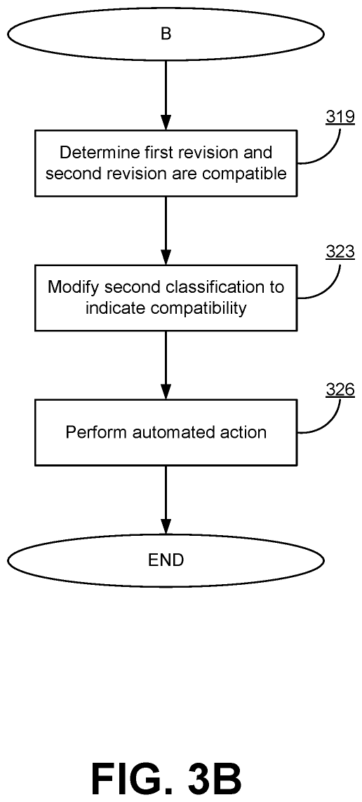

Referring next to FIGS. 3A and 3B, shown is a flowchart 300 that provides one example of the operation of a portion of the schema management application 116. The flowchart of FIGS. 3A and 3B provide merely an example of the many different types of functional arrangements that can be employed to implement the operation of the depicted portion of the schema management application 116. As an alternative, the flowchart of FIGS. 3A and 3B can be viewed as depicting an example of elements of a method implemented within the network environment 100.

Beginning with block 303, the automatic versioning alignment service 119 of the schema management application 116 determines the versioning model 159 of the schema lifecycle 153. In some examples, the schema management application 116 obtains the versioning model 159 of the schema lifecycle 153 from the management data store 133. In other examples, the schema management application can determine that the versioning model 159 of the schema lifecycle 153 is a semantic versioning model. In some examples, the schema management application can determine that the versioning model 159 of the schema lifecycle 153 is a sequence-based model, a change significance model, a degree or a degree of compatibility model, etc. In other examples, the user can provide the versioning model 159 via the administrator schema application 179.

At block 306, the automatic versioning alignment service 119 of the schema management application 116 can store the versioning model 159 in the management data store 133. The versioning model 159 can contain the one or more classifications 146 of the versioning model 159.

At block 309, the automatic versioning alignment service 119 of the schema management application 116 determines a first classification 146 for the first revision 143 of the schema 136. In some examples, the classification 146 can be based at least in part on the versioning model 159. For example, the classification 146 of the first revision 143 of the schema 136 can be “major,” “minor,” or “patch,” based at least in part on the semantic versioning model. In other examples, the classification 146 of the first revision 143 of the schema 136 can be provided by the user via the administrator schema application 179.

At block 313, the automatic versioning alignment service 119 of the schema management application 116 identifies the second revision 143 of the schema 136. In some examples, the second revision 143 can include changes to the schema 136 different from the first revision 143 of the schema 136. In some examples, the second revision 143 can contain required or optional data attributes. In other examples, the second revision 143 can contain required and optional data attributes. In other examples, the second revision can contain additional data types or data formats.

At block 316, the automatic versioning alignment service 119 of the schema management application 116 determines the classification 146 of the second revision 143 of the schema 136 based at least in part on the versioning model 159 and the one or more classification rules 166. In some examples, the schema management application 116 can determine the classification 146 of the second revision 143 of the schema 136 is major, minor, or patch. In other examples, the schema management application 116 can determine the classification 146 of the second revision 143 of the schema 136 is based at least in part on the user provided versioning model 159.

At block 319, the automatic versioning alignment service 119 of the schema management application 116 determines that the first revision 143 of the schema 136 and the second revision 143 of the schema 136 are compatible. The schema management application 116 can determine compatibility based at least in part on the one or more compatibility rule(s) 169.

At block 323, the automatic versioning alignment service 119 of the schema management application 116 modifies the second classification 146 of the second revision 143 of the schema 136. The modification of the second classification 146 of the second revision 143 of the schema 136 can indicate compatibility between the first revision 143 and the second revision 143. In some examples, the second revision 143 of the schema 136 can be set as the active revision 143.

At block 326, the automatic versioning alignment service 119 of the schema management application 116 can perform an automated action. The automated action can be based at least in part on the second revision 143 of the schema 136 being compatible with the first revision 143 of the schema. In some examples, the schema management application 116 can execute the automatic versioning alignment service 119 to perform the automated action. For example, the automated action could include generating the compatibility notification(s) 156, modifying the classification 146 of the revision(s) 143, or initiating installation of the revision(s) 143.

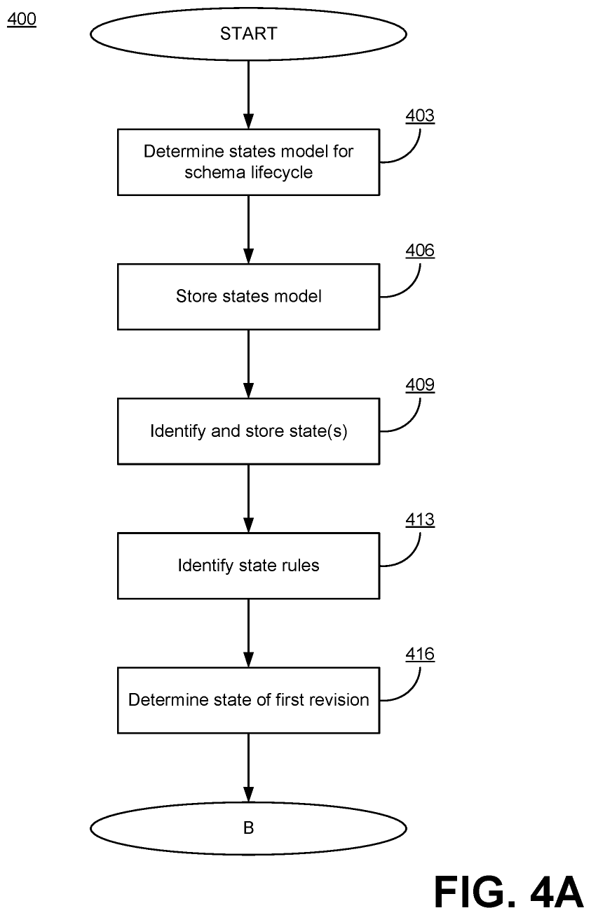

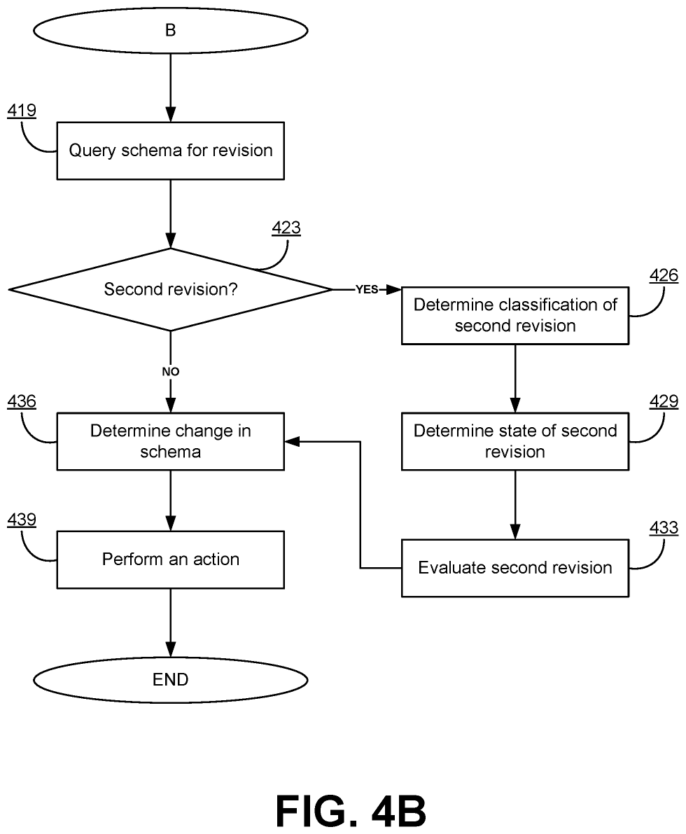

Referring next to FIGS. 4A and 4B, shown is a flowchart 400 that provides one example of the operation of a portion of the schema management application 116. The flowchart of FIGS. 4A and 4B provide merely an example of the many different types of functional arrangements that can be employed to implement the operation of the depicted portion of the schema management application 116. As an alternative, the flowchart of FIGS. 4A and 4B can be viewed as depicting an example of elements of a method implemented within the network environment 100.

Beginning with block 403, the automatic state management service 123 of the schema management application 116 can determine the states model 163 for the schema lifecycle 153. The states model 163 can be stored in the management data store 133. In other examples, the schema management application can determine the states model 163 of the schema lifecycle 153 is the five-stage model. In other examples, the user can provide the states model 163 via the administrator schema application 179.

At block 406, the automatic state management service 123 of the schema management application 116 can store the states model 163 in the management data store 133. The states model 163 contains the states 149.

At block 409, the automatic state management service 123 of the schema management application 116 can identify the states 149 contained in states model 163. Further, the schema management application 116 can store the states 149 in the management data store 133. In other examples, the schema management application 116 can determine the states 149 based at least in part on the user provided states model 163.

At block 413, the automatic state management service 123 of the schema management application 116 can identify the one or more state rule(s) 173. In some examples, the state rule(s) 173 can be used by the schema management application 116 to determine the first state 149 of the first revision 143. In other examples, the state rule(s) 173 can be used by the schema management application to assign the second state 149 to the first revision 143.

At block 416, the automatic state management service 123 of the schema management application 116 can determine a first state 149 of the first revision 143. The first state 149 of the first revision 143 can be based at least in part on the states model 163. In some examples, the first state 149 can be based at least in part on the one or more state rule(s) 173. In other examples, the first state 149 can be based at least in part on the compatibility rule(s) 169. In other examples, the first state 149 can be based at least in part on the states 149 of the user provided states model 163. In other examples, the state rule(s) 173 can be stored in the management data store 133.

At block 419, the automatic state management service 123 of the schema management application 116 can query the schema 136 for the second revision 143. In some examples, In the absence of the second revision, the schema management application can perform an automated action. For example, an automated action could include generating the compatibility notification(s) 156, modifying the state 149 of the revision(s) 143, or initiating installation of the revision(s) 143.

At block 423, in response to querying the schema 136 for the second revision, the schema management application 116 can move to block 426 to evaluate the second revision. At block 426, the schema management application 116 can determine a second classification 146 based at least in part on the versioning model 159. In other examples, the second classification 146 can be based at least in part on the classification rule(s) 166.

At block 429, the automatic state management service 123 of the schema management application 116 can determine a second state 149 for the second revision 143 of the schema 136. In some examples, the second state 149 can be determined based at least in part on the states model 163. In other examples, the second state 149 can be determined based at least in part on the one or more state rule(s). In other examples, the second state 149 can be determined based at least in part on the first classification.

At block 433, the automatic state management service 123 of the schema management application 116 can evaluate the second revision 143 for changes. In some examples, the change in the second revision 143 can be the data type or data format. In other examples, the schema management application can evaluate the second revision 143 for required or optional data attributes.

At block 436, the automatic state management service 123 of the schema management application 116 can compare the data attributes of the first revision 143 and the second revision 143. In some examples, the schema management application can determine the changes between the first revision 143 and the second revision 143 are optional data attributes. In other examples, the schema management application 116 can determine the second revision 143 contains required data attributes that are not present in the first revision 143 of the schema 136.

At block 439, the automatic state management service 123 of the schema management application 116 can perform an automated action. The automated action can be based at least in part on the changes in the schema 136. In some examples, the schema management application 116 can execute the automatic state management service 123 to perform the automated action. For example, the automated action could include generating the compatibility notification(s) 156, modifying the classification 146 of the revision(s) 143, or initiating installation of the revision(s).

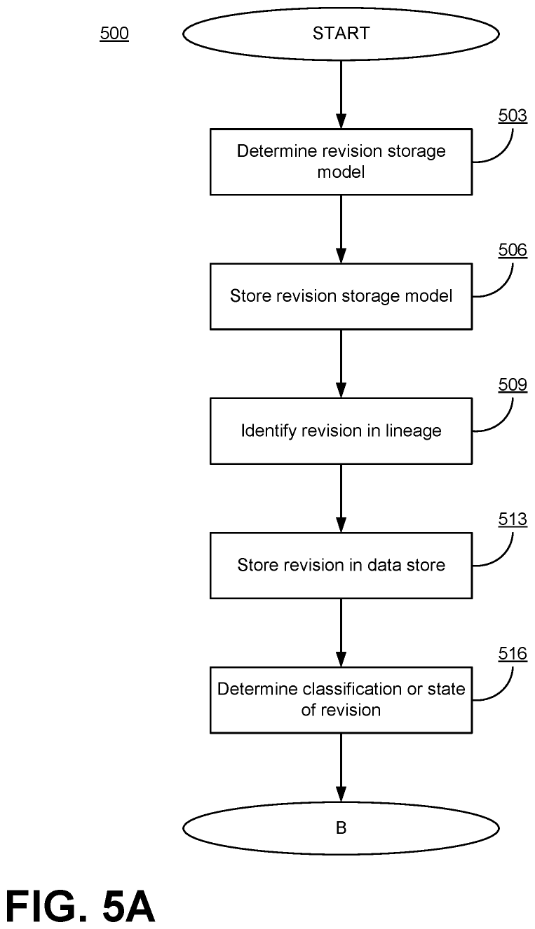

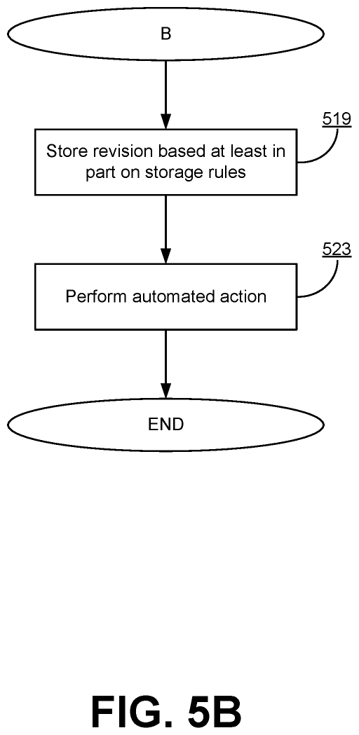

Referring next to FIGS. 5A and 5B, shown is a flowchart 500 that provides one example of the operation of a portion of the schema management application 116. The flowchart of FIGS. 5A and 5B provide merely an example of the many different types of functional arrangements that can be employed to implement the operation of the depicted portion of the schema management application 116. As an alternative, the flowchart of FIGS. 5A and 5B can be viewed as depicting an example of elements of a method implemented within the network environment 100.

Beginning with block 503, the automatic revision storage service 126 of the schema management application 116 can determine a revision storage model. The revision storage model can be based at least in part on the versioning model 159 and the states model 163. In other examples, the revision storage model can be based at least in part on the classification rule(s) 166 and state rule(s) 173. In other examples, the revision storage model can be based at least in part on the storage rule(s) 176. In other examples, the revision storage model can be based at least in part on the user provided revision storage model.

At block 506, the automatic revision storage service 126 of the schema management application 116 can store the revision storage model. The revision storage model can be stored in the management data store 133.

At block 509, the automatic revision storage service 126 of the schema management application 116 can identify the first revision 143 in a first schema lineage 139. In some examples, the lineage 139 is contained in the schema 136. In some examples, the schema 136 can contain one or more of the lineage(s) 139. In other examples, the schema 136 can contain the temporary lineage 139.

At block 513, the automatic revision storage service 126 of the schema management application 116 can store the first revision in the management data store 133. In some examples, the schema management application 116 can store the first revision 143 in the lineage 139 of the schema 136. In other examples, the schema management application 116 can store the first revision 143 in the temporary lineage 139 of the schema 136.

At block 516, the automatic revision storage service 126 of the schema management application 116 can determine the first classification 146 and the first state 149 of the first revision 143 of the schema 136. In some examples, the first classification can be based at least in part on the versioning model 159. In other examples, the first state 149 can be based at least in part on the states model 163.

In some examples, the schema management application 116 can execute the automatic versioning alignment service 199 to determine the first classification 146 of the first revision 143. In other examples, the schema management application 116 can execute the automatic state management service 123 to determine the state 149 of the first revision 143.

At block 519, the automatic revision storage service 126 of the schema management application 116 can store the first revision with the first classification and the first state in the schema 136. In some examples, the schema management application 116 can store the first revision of the schema 136 based at least in part on the one or more storage rule(s) 176.

At block 523, the automatic revision storage service 126 of the schema management application 116 can perform an automated action. The automated action can be based at least in part on storing the first revision in the schema 136. In some examples, the schema management application 116 can execute the automatic revision storage service 126 to perform the automated action. For example, the automated action could include generating the temporary lineage(s) 139, generating the temporary schema storage 203, generating the temporary revision(s) 143, or initiating installation of the revision(s) 143.

A number of software components previously discussed are stored in the memory of the respective computing devices and are executable by the processor of the respective computing devices. In this respect, the term “executable” means a program file that is in a form that can ultimately be run by the processor. Examples of executable programs can be a compiled program that can be translated into machine code in a format that can be loaded into a random access portion of the memory and run by the processor, source code that can be expressed in proper format such as object code that is capable of being loaded into a random access portion of the memory and executed by the processor, or source code that can be interpreted by another executable program to generate instructions in a random access portion of the memory to be executed by the processor. An executable program can be stored in any portion or component of the memory, including random access memory (RAM), read-only memory (ROM), hard drive, solid-state drive, Universal Serial Bus (USB) flash drive, memory card, optical disc such as compact disc (CD) or digital versatile disc (DVD), floppy disk, magnetic tape, or other memory components.

The memory includes both volatile and nonvolatile memory and data storage components. Volatile components are those that do not retain data values upon loss of power. Nonvolatile components are those that retain data upon a loss of power. Thus, the memory can include random access memory (RAM), read-only memory (ROM), hard disk drives, solid-state drives, USB flash drives, memory cards accessed via a memory card reader, floppy disks accessed via an associated floppy disk drive, optical discs accessed via an optical disc drive, magnetic tapes accessed via an appropriate tape drive, or other memory components, or a combination of any two or more of these memory components. In addition, the RAM can include static random access memory (SRAM), dynamic random access memory (DRAM), or magnetic random access memory (MRAM) and other such devices. The ROM can include a programmable read-only memory (PROM), an erasable programmable read-only memory (EPROM), an electrically erasable programmable read-only memory (EEPROM), or other like memory device.

Although the applications and systems described herein can be embodied in software or code executed by general purpose hardware as discussed above, as an alternative the same can also be embodied in dedicated hardware or a combination of software/general purpose hardware and dedicated hardware. If embodied in dedicated hardware, each can be implemented as a circuit or state machine that employs any one of or a combination of a number of technologies. These technologies can include, but are not limited to, discrete logic circuits having logic gates for implementing various logic functions upon an application of one or more data signals, application specific integrated circuits (ASICs) having appropriate logic gates, field-programmable gate arrays (FPGAs), or other components, etc. Such technologies are generally well known by those skilled in the art and, consequently, are not described in detail herein.

The flowcharts show the functionality and operation of an implementation of portions of the various embodiments of the present disclosure. If embodied in software, each block can represent a module, segment, or portion of code that includes program instructions to implement the specified logical function(s). The program instructions can be embodied in the form of source code that includes human-readable statements written in a programming language or machine code that includes numerical instructions recognizable by a suitable execution system such as a processor in a computer system. The machine code can be converted from the source code through various processes. For example, the machine code can be generated from the source code with a compiler prior to execution of the corresponding application. As another example, the machine code can be generated from the source code concurrently with execution with an interpreter. Other approaches can also be used. If embodied in hardware, each block can represent a circuit or a number of interconnected circuits to implement the specified logical function or functions.

Although the flowcharts show a specific order of execution, it is understood that the order of execution can differ from that which is depicted. For example, the order of execution of two or more blocks can be scrambled relative to the order shown. Also, two or more blocks shown in succession can be executed concurrently or with partial concurrence. Further, in some embodiments, one or more of the blocks shown in the flowchart diagrams can be skipped or omitted. In addition, any number of counters, state variables, warning semaphores, or messages might be added to the logical flow described herein, for purposes of enhanced utility, accounting, performance measurement, or providing troubleshooting aids, etc. It is understood that all such variations are within the scope of the present disclosure.

Also, any logic or application described herein that includes software or code can be embodied in any non-transitory computer-readable medium for use by or in connection with an instruction execution system such as a processor in a computer system or other system. In this sense, the logic can include statements including instructions and declarations that can be fetched from the computer-readable medium and executed by the instruction execution system. In the context of the present disclosure, a “computer-readable medium” can be any medium that can contain, store, or maintain the logic or application described herein for use by or in connection with the instruction execution system. Moreover, a collection of distributed computer-readable media located across a plurality of computing devices (e.g, storage area networks or distributed or clustered filesystems or databases) can also be collectively considered as a single non-transitory computer-readable medium.

The computer-readable medium can include any one of many physical media such as magnetic, optical, or semiconductor media. More specific examples of a suitable computer-readable medium would include, but are not limited to, magnetic tapes, magnetic floppy diskettes, magnetic hard drives, memory cards, solid-state drives, USB flash drives, or optical discs (e.g., compact discs (CD-ROMS), digital video discs (DVDs), holographic memory, etc.). Also, the computer-readable medium can be a random access memory (RAM) including static random access memory (SRAM) and dynamic random access memory (DRAM), or magnetic random access memory (MRAM). In addition, the computer-readable medium can be a read-only memory (ROM), a programmable read-only memory (PROM), an erasable programmable read-only memory (EPROM), an electrically erasable programmable read-only memory (EEPROM), or other type of memory device.

Further, any logic or application described herein can be implemented and structured in a variety of ways. For example, one or more applications described can be implemented as modules or components of a single application. Further, one or more applications described herein can be executed in shared or separate computing devices or a combination thereof. For example, a plurality of the applications described herein can execute in the same computing device, or in multiple computing devices in the same computing environment.

Disjunctive language such as the phrase “at least one of X, Y, or Z,” unless specifically stated otherwise, is otherwise understood with the context as used in general to present that an item, term, etc., can be either X, Y, or Z, or any combination thereof (e.g., X; Y; Z; X or Y; X or Z; Y or Z; X, Y, or Z; etc.). Thus, such disjunctive language is not generally intended to, and should not, imply that certain embodiments require at least one of X, at least one of Y, or at least one of Z to each be present.

It should be emphasized that the above-described embodiments of the present disclosure are merely possible examples of implementations set forth for a clear understanding of the principles of the disclosure. Many variations and modifications can be made to the above-described embodiments without departing substantially from the spirit and principles of the disclosure. All such modifications and variations are intended to be included herein within the scope of this disclosure and protected by the following claims.

Therefore, the following is claimed:

1. A system, comprising:
a computing device comprising a processor and a memory; and
machine-readable instructions stored in the memory that, when executed by the processor, cause the computing device to at least:
determine a versioning model for a schema lifecycle;
determine a first classification for a first revision of a schema based at least in part on the versioning model and one or more classification rules;
identify a second revision of the schema;
determine a second classification for the second revision of the schema based at least in part on the versioning model and one or more classification rules;
determine that the first revision of the schema is compatible with the second revision of the schema based at least in part on one or more compatibility rules;
modify the second classification of the second revision of the schema to indicate that the first revision of the schema is compatible with second revision of the schema; and
perform an automated action based at least in part on the second revision of the schema being compatible with the first revision of the schema.

2. A system of claim 1, wherein the machine-readable instructions that cause the computing device to perform the action further cause the computing device to modify at least one of:
the classification of the second revision of the schema; or
the classification of a subsequent revision of the schema.

3. A system of claim 1, wherein the machine-readable instructions that cause the computing device to perform the action further cause the computing device to at least generate one or more compatibility notifications.

4. A system of claim 3, wherein the machine-readable instructions that cause the computing device to perform the action further cause the computing device to at least:
store the one or more compatibility notifications;
send the one or more compatibility notifications; or
send a request that directs a client device to display the one or more compatibility notifications.

5. A system of claim 1, wherein the machine-readable instructions, when executed by the processor, further cause the computing device to at least initiate installation of the second revision of the schema based at least in part on the determination of compatibility.

6. A system of claim 1, wherein the versioning model is based at least in part on a semantic versioning model.

7. A system, comprising:
a computing device comprising a processor and a memory; and
machine-readable instructions stored in the memory that, when executed by the processor, cause the computing device to at least:
determine a states model for a schema lifecycle;
determine a first state for a first revision of a schema based at least in part on the states model;
identify a second revision of the schema;
determine a first classification of the second revision of the schema;
determine a second state for the second revision of the schema based at least in part on the states model, one or more of state rules, and the first classification;
evaluate the second revision of the schema;
determine a change in the schema between the first revision of the schema and the second revision of the schema; and
perform an automated action based at least in part on the change in the schema.

8. The system of claim 7, wherein the machine-readable instructions that cause the computing device to perform the action further cause the computing device to at least:
transition the schema lifecycle from the first revision of the schema to the second revision of the schema; and
modify the first revision of the schema with the first state to at least one of a deprecated state or retired state.

9. The system of claim 7, wherein the machine-readable instructions that cause the computing device to determine the states model further cause the computing device to at least:
determine the first state is a live state; and
transition the schema lifecycle from the first state to the live state.

10. The system of claim 7, wherein the machine-readable instructions that cause the computing device to determine the states model further cause the computing device to at least identify the first state is a draft state.

11. The system of claim 7, wherein the machine-readable instructions that cause the computing device to determine the states model further cause the computing device to at least:
determine the first state is a deprecated state; and
transition the schema lifecycle from the first state to the deprecated state.

12. The system of claim 7, wherein the machine-readable instructions that cause the computing device to determine the states model further cause the computing device to at least:
determine the first state is a retired state;
transition the schema lifecycle from the first state to a retired state; and
create a second lineage.

13. The system of claim 9, wherein the machine-readable instructions that cause the computing device to determine the states model further cause the computing device to at least:
determine the first state is a discarded state; and
in response to a determination of the discarded state, perform an action based at least in part on one or more state rules.

14. The system of claim 7, wherein the schema comprises of one or more data structures.

15. A system, comprising:
a computing device comprising a processor and a memory; and
machine-readable instructions stored in the memory that, when executed by the processor, cause the computing device to at least:
determine a revision storage model based at least in part on a versioning model and a states model;
identify a first schema stored in a data store;
identify a first revision in a first schema lineage, wherein a lineage is contained in a schema;
determine a first classification and a first state of the first revision of the schema;
determine one or more storage rules;
in response to a determination of at least one of the first classification or the first state of the first revision, store the first revision based at least in part on the one or more storage rules; and
perform an automated action based at least in part on storing the first revision based at least in part on the one or more storage rules.

16. The system of claim 15, causing the computing device to further store the first revision in a temporary lineage.

17. The system of claim 16, further comprising:
storing the state of the revision based at least in part on the one or more storage rules; and
modifying the state of the revision to the first state.

18. The system of claim 15, wherein the first state or the first classification of the first revision is transitioned to a second state or second classification.

19. The system of claim 15, wherein the first revision is stored in the first schema lineage based at least in part on the first state.

20. The system of claim 15, wherein the first revision is stored in the first schema lineage based at least in part on the first classification.
